(19) United States
(12) Patent Application Publication
(10) Pub. No.: US 2020/0058055 A1
(43) Pub. Date: Feb. 20, 2020

(54) BLOCKCHAIN FOR THE COMMON GOOD: DIGITAL CURRENCY FOR CITIZEN PHILANTHROPY AND SOCIAL ENTREPRENEURSHIP

(71) Applicant: The George Washington University, Washington, DC (US)

(72) Inventors: Rahul SIMHA, Springfield, VA (US); Shweta JAIN, Forest Hills, NY (US)

(21) Appl. No.: 16/543,661

(22) Filed: Aug. 19, 2019

Related U.S. Application Data
(60) Provisional application No. 62/719,214, filed on Aug. 17, 2018.

(51) Int. Cl. G06Q 30/02; G06F 16/2458; G06Q 20/40

(52) U.S. Cl. CPC G06Q 30/0279; G06Q 20/40; G06F 16/2458

(57) ABSTRACT

A distributed ledger application for the world of citizen philanthropy and social entrepreneurship, with stakeholder incentives designed to increase social good through accountability, transparency, and flexibility. In this system, called Directed Cash, individual donors specify conditions (the “Directed” part) attached to their donation or investment (“Cash”), that are then efficiently paired with interested recipients or aggregators of recipients (charities, social entrepreneurs) using distributed consensus so that the intent and pairing are open while maintaining donor anonymity. Furthermore, Directed Cash flows both ways to promote accountability and transparency: after receipt, a validation flows backwards to return to the donor so that the donor receives a report of how their donation was spent. While some elements of the system borrow from existing cryptocurrency and blockchain technologies, we propose alternative incentives for distributed consensus that are better aligned with the application and promote social good through the stakeholders. This invention is for a system design to achieve these goals, a primary feature of which is a simple SQL-like language to enable specifying conditions, pairing, aggregation and publicly-verifiable reporting.

### RELATED APPLICATIONS

This application claims the benefit of U.S. Provisional Application No. 62/719,214, filed Aug. 17, 2018, the entire contents of which are incorporated herein by reference.

### BACKGROUND OF THE INVENTION

### Field of the Invention

The present invention relates to blockchain technology. More particularly, the present invention introduces a novel method of using blockchain technology along with algorithmic pairing to efficiently distribute resources in a blockchain network.

### Background of the Related Art

Citizen donors or investors concerned about the impact of their contributions face a daunting gamut of choices. For charitable donations, for example, they must either trust a well-established charity by contributing to its general fund or spend time scouring crowd-funding sites for particular projects of interest. Not only is this donor-to-cause pairing problem time-consuming for donors, it forces charities to spend precious resources competing for eyeballs. But most importantly, there are few opportunities for ordinary donors to specify in much detail how they want their contributions spent, and nearly impossible to verify that their donations were spent as intended. These shortcomings raise a useful question: can a marketplace of philanthropic transactions be infused with the technology to improve efficiency and create a virtuous cycle that steers stakeholders towards the greater common good?

In the present invention, the following combination of technologies is well-suited to addressing the above question. First, a digital currency (called Directed Cash here) that allows donors to attach conditions to a donation such as the type and location of aid, a cap on organizational overhead, and other such expressions of donor intent. Second, a pairing algorithm to connect donations to charities and causes. Third, a distributed ledger so that the system functions without a trusted third party. Fourth, a linked structure within the distributed ledger that allows the backward flow of transactions, connecting expenditures to the original donors so that donors may receive confirmation that their stated intent was satisfied. And finally, a high-level query language called DCL (Directed Cash Language) to facilitate clear expression of donor intent and recipient action. These components provide a system that is effective in reaching the overall goal of directing donations to causes that matter to donors.

### Directed Cash (DC)

The new digital currency is linked to government backed currency through a central bank. Unlike Bitcoin, our goal is not to gain independence from the government and nor do we want the currency itself to become an investment vehicle. Instead DC is merely a transactional convenience that allows a donor to direct spending to favorite causes and with conditions important to them.

### Algorithmic Pairing

With algorithmic pairing, donations are not pledged to an organization but to a cause, aligning the donors' will with the needs of potential recipients. Analogous to program trading in stock markets, algorithmic pairing has the potential to mitigate human bias and result in socially more optimal allocation of resources, It also helps address the problem of irrational herding [1], in which popular projects tend to attract new investors even if other deserving projects are better suited to investor intent. Just as importantly, we organically establish an open verifiable system which enables donors motivated by public recognition [2] to tout their contribution but also to stimulate others into providing “matching contributions.”

### Distributed Ledger:

Because transparency promotes good behavior amongst the stakeholders, a publicly verifiable distributed ledger without a trusted third party appears to be a promising approach, with the advantage of spreading the verification burden, and facilitating a low barrier to entry (and exit): anyone with the software can join or leave as they please. As long as there is sufficient interest in the application, we presume there will be sufficient honest nodes to keep the application functioning with integrity. However, a proof-of-work or similar blockchain based. system is unnecessary for our application, and even computationally infeasible for the types of stakeholders in our realm of interest. Instead, a general consensus scheme with alternative incentives is more suitable to address the somewhat more benign threat model, as explained later.

Therefore, a permissioned blockchain [3] is provided that has the following. First, anyone can send a query to the chain to perform accounting, auditing and reporting tasks. Only bona fide banks can generate transaction IDs that accompany donation pledges and claims. Only registered charities can send DCL statements containing information about a cause, and only registered vendors can send claims with invoices for payments for goods and services, both via their tax IDs. Anyone with a bank account or credit card can send donation pledge with attached conditions. Permitted parties consisting of vendors, charities, regulators, banks and donors participate in maintaining the blockchain.

### Vendor's Workflow

A vendor needs to be able to query existing calls, make bids, and rate recipient aggregators. Then, it is up to a recipient to accept the bid and complete the transaction. A completed transaction then results in the vendor posting the receipt on the ledger. This process works as follows:

The vendor may visit a website hosted by donor or charity aggregators to browse funded projects. They can create a query much in the same way as donors but with categories customized to better represent a vendor/supplier's perspective. For example, the categories may be food, health supplies, educational services, nursing etc. Once they locate a project that their business has the capacity to serve, they are able to place a bid which may need approval from the recipient of the goods or service. Once a bid is accepted, and services have been rendered, the vendor is able to submit signed receipts and invoices through any partner organization's website (donor aggregator, vendor, blockchain partner, government entity etc.). A typical vendor claim, as it would appear in the system, is reproduced below:

### 1, FROM Fresh House Grocery (ID= . . . ) CLAIM $550 FROM Bright Ray

2. Charity WHERE (SCHEMA=1.1) AND PROJECT=Food Drive 2018 AND (CATEGORY=food.canned.soup) DESC UR
3. http://fhg/search.html?prodid=98735

The backend server (i.e., processing device) placed in the organization's website would then send a payment authorization to the donor's bank which will fulfil the payment and send a “Donation claimed” transaction to the blockchain.

### Directed Cash Language:

Since a working system needs a compact and precise way to specify donations as well as causes, we describe a preliminary design for a high-level SQL-like language called DCL (Directed Cash Language). The language facilitates querying, donating with conditions, automated pairing, reporting, and verification. Is another, smart-contract like language needed? We aim to strike a balance between the full expressibility and high vulnerability of a Turing-complete language [4] and a fixed-format predetermined list of allowable donation categories that cannot anticipate future needs, and which restricts the creativity of projects and aggregators. We propose a compromise by using a carefully constrained non-Turing complete language along the lines of SQL. For databases. SQL combines enough expressibility for simple querying with simplicity in syntax, and most importantly, can be fully validated (and also optimized for execution speed) at runtime.

A constrained language is one part of reducing system complexity (which can be maliciously gamed [5]). We mention two others. First, actual transactions involving money in our system use the standard banking system; the Directed cash is simply a token that attaches a dollar amount to be drawn from an actual bank in accordance with a donor's intent. When a donation is spent by a recipient, a donor's reference to the funds is fulfilled by a central bank that holds the money in reserve. Second, the only algorithmic component is pairing, which is achieved by a deterministic open-source algorithm. Thus, the only potential security loopholes are of two kinds: the standard ones with any existing digital payment system, and any “gaming” of the incentives for the stakeholders.

### SUMMARY OF THE INVENTION

A mechanism is provided for donors/investors specifying constraints that go along with their digital cash contributions. An algorithm for pairing donors with causes and non-profits/charities is also presented. A mechanism for distributed ledgers based on blockchain principles but different in that it does not require the intensive computational power required by Bitcoin is presented. A mechanism for reporting and accountability so that donors/investors receive some guarantees that their investments were spent as intended is also introduced.

A mechanism for public verifiability of the ledger in explained in this disclosure. A mechanism for detecting and safeguarding against certain security attacks. A programming language called Directed Cash Language for describing all of the above and enabling efficient distribution is introduced. The only current digital currency systems that support carrying “conditions” are smart-contract systems. However, these are limited in purpose: they are intended to describe conditions attached to particular transactions, and it is known that general purpose smart-contracts are open to various security threats. In contrast, Directed Cash has a simple way of specifying conditions that can be matched against a variety of causes.

The Directed Cash system supports a programming language (DCL) for easy specification and reporting. DCL is not Turing-complete, which means it is far safer than a general-purpose programming language. Because of its simplicity, the DCL language is also optimizable. There is no other system for the world of charitable donations and social entrepreneurship with all the features described: cash with conditions, public verifiability, reverse accounting flow, project definitions, automated pairing.

These and other objects of the invention, as well as many of the intended advantages thereof, will become more readily apparent when reference is made to the following description, taken in conjunction with the accompanying drawings.

### BRIEF DESCRIPTION OF THE FIGURES

FIG. 1 shows a high-level diagram of the system in accordance with the embodiment of the invention.

FIG. 2 shows a more in-depth diagram of the entities involved in the blockchain in accordance with an embodiment of the invention.

FIG. 3 shows the structure of an exemplary block in the blockchain used by in a system in accordance with an embodiment of the invention.

FIG. 4 shows a diagram of a method by which a transaction is processed in the blockchain, in accordance with an embodiment of the invention.

FIG. 5 is a flowchart outlining a method by which the DCL engine processes a transaction in accordance with an embodiment of the invention.

FIG. 6 is a flowchart outlining a method by which the DCL engine builds a specification for a charity in accordance with an embodiment of the invention.

FIG. 7 is a flowchart outlining a method by which the DCL engine validates and verifies fund availability in accordance with an embodiment of the invention.

FIG. 8 is a flowchart outlining a method by which a vendor is compensated in accordance with an embodiment of the invention.

FIG. 9 is a flowchart outlining a method of pairing used in accordance with an embodiment of the invention.

FIG. 10A is diagram showing an exemplary breakdown of the “Education” category for charitable donations.

FIG. 10B is a diagram showing an exemplary breakdown of the “Healthcare” category for charitable donations.

### DETAILED DESCRIPTION OF THE INVENTION

In describing the illustrative, non-limiting embodiments of the invention illustrated in the drawings, specific terminology will be resorted to for the sake of clarity. However, the invention is not intended to be limited to the specific terms so selected, and it is to be understood that each specific term includes all technical equivalents that operate in similar manner to accomplish a similar purpose. Several embodiments of the invention are described for illustrative purposes, it being understood that the invention may be embodied in other forms not specifically shown in the drawings.

### Stakeholders and Their Needs

The stakeholders in an exemplary embodiment of the system are identified as follows:
Donors are typically individuals or foundations who invest in a project, a cause, or an organization that supports their cause.
A recipient is the ultimate target of a donation, typically an individual. A project is a fixed-duration enterprise with a specified outcome; thus, a project can be a collection of recipients along with spending goals, or a collection of physical items (such as habitat materials).
A vendor is a commercial entity that provides goods and services to projects or recipients; examples include grocery stores, landlords, social workers. Most importantly, a vendor's legally-bound receipts form the basis of validating expenditures.
An aggregator brings together donors, projects, dor recipients under one theme or organization. For example, a donor aggregator can offer to match contributions from other donors, whereas a recipient aggregator more closely resembles a charity that features projects and member recipients. Many foundations are often a mix of recipient and donor aggregator. In our system, such organizations would have to separately list themselves in both categories if they wish to offer both functionalities.
A regulator represents a third party solely interested in ensuring the system functioning as designed; such as a government oversight agency.

### 4. What Donors Seek

Economic analyses of donor motivations demonstrate a variety of intent [2] much of it deeply personal [6], arguing for a flexible system that accommodates all types of donor motivation. What is equally clear is the desire among donors to monitor and evaluate outcomes from their contributions [7], [8], [9], to find the right opportunity, and to use public announcements for recognition or to stimulate others [2]. Thus, for the purposes of this invention, a design with the following features is preferable:
Donors should be able to easily attach directions with their contributions, such as “I want my donations to go only to food costs, through charities that have lower than 10% overhead and who operate in my state.”
Donors should receive as complete an accounting as possible of how their money was spent.
Donors should not have to spend much time searching for projects that meet their interest, nor to check how their contributions get spent even if they have full accounting.
Beyond the transfer of funds at the time of purchasing Directed Cash, donors should have the option of maintaining anonymity. Yet, donors wish public recognition or to stimulate others via matching contributions should be able to do so easily.

### What Aggregators Seek

Aggregator features center around automation and efficiency.
It should be easy for recipient aggregators to define projects and their attributes in ways that promote optimal pairing or large-scale aggregation.
The system should enable effective stakeholders to stand out. Thus, attributes such as low-overhead or low-cost should be easily available as conditions.

### Features for Vendors

It is assumed that vendors are commercial entities ultimately interested in profit. However, we exploit the fact that indirect outcomes that lead to profit, such as advertising and reputation, are just as desirable, One of the most important system features is a reputational incentive for vendors to report on spending from recipients. This creates a virtuous cycle whereby responsive vendor are rewarded by having donated funds reach their products. Also, through the systems public verifiability, a vendor can acquire positive reputation that impacts its other customers, in much the same way that commercial entities that support social causes enhance their standing in society.

### Other Desirable System Properties

The overriding goal of our proposed system is to incentivize all stakeholders to fulfill their role in making the system work, and in doing so, achieve better outcomes for all. Thus, we need mechanisms that align the common good with each stakeholder's goals to advance their own interests. Since aggregators and vendors seek recognition, we propose a points-based reward system to enable these stakeholders to rise in rankings by paining points for participation (successfully constructing the next, block) in distributed consensus. This, together with a mechanism to prevent domination by any particular stakeholder, helps us avoid the burden of proof of work blockchains. Finally, stakeholders should be able to make changes to the system through the consensus approach. This is particularly relevant for sanctifying nomenclature (what constitutes food) and rankings (of vendors).

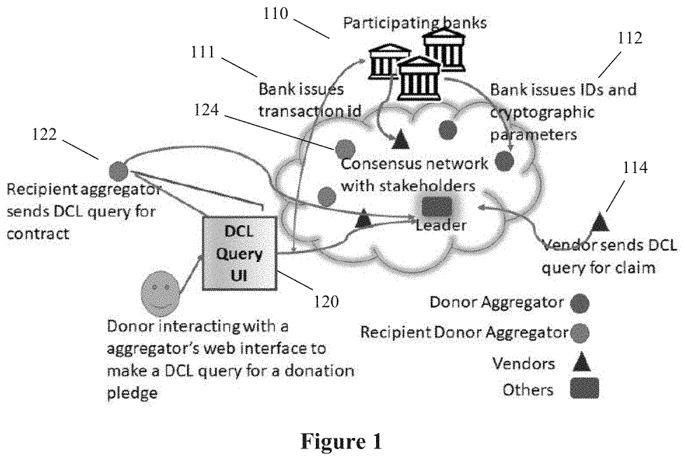

FIG. 1 shows a high-level diagram of the system n accordance with the embodiment of the invention. The diagram serves to show an exemplary interaction between stakeholders. The stakeholders include the participating banks 110, the vendor 114, the donor who interacts with the DCL. Query User Interface (UI) 120, and the recipient aggregator that sends the DCL query for a contract 122. The blockchain network 124, also referred to as a consensus network, connects all stakeholders. As shown in the diagram, the donor who interacts with the DCL Query User Interface (UI) 120, which is an aggregator's web interface, running on standard computer systems. The donor 120 makes a DCL query for a donation pledge. The recipient aggregator 122 receives the query from the donor for the contract (here, a donation). The transaction then enters the blockchain network 124, where it is received by the participating banks 110. The participating banks 110 issue a transaction ID 111 for the contract, as well as issuing cryptographic parameters 112 for the contract. Similarly, a vendor 114 sends a DCL query into the blockchain network 124 for a claim (a request) for resources. In the blockchain network, open contracts and pending claims are algorithmically paired, as will be explained further below.

### How Directed Cash Works

It is assumed that donor aggregators or crowd-funding platforms will offer donors a user-friendly interface and will connect through the banking system to enable donors to both make contributions and specify their conditions in a convenient manner. Aggregators, vendors, regulators, and any member of the public may operate a Directed Cash server (DC-server) that participates in the computations of the system. The computational goals of the system (algorithmic pairing, validation, reporting, recognition) are achieved through the distributed computation that occurs amongst these servers. In particular, servers jointly agree through distributed consensus on the public ledger that includes anonymized donations, their pairings with recipients or projects, vendor validation, rankings, and reports sent back to donors. As mentioned earlier, this is a permissioned chain and hence all participants in the consensus process will need to be registered. Yet, participants are subject to malicious intent as well as external attack and hence protection needs to be built to counter associated security risks as described below.

Because donors' conditions can greatly vary, there needs to be a simple way to let donors specify their conditions. To enable efficient and simple to use systems, we propose knowledge-representation systems using ontologies [10], that have predefined categories and hierarchies of accepted terms. We merely enable the use of any tree-structured ontology (such as those described in [11], [12]), along with a distributed mechanism to alter the ontology as needed.

### The Directed Cash Language (DCL)

Rather than present a formal description of the language that is more suited to a tech report, we outline the language's features through examples typical for the stakeholders.

1) Identity and authentication: Because every DCL transaction (query and statement) will feature the writer's identity, and will itself have a unique ID), we first address the question of how stakeholders are identified and authenticated. The identity and authentication part of the system is not central to the contributions of the invention and thus we see any of several approaches as roughly equal, with competing advantages.

The first approach is to have the system require a single central bank or a digital payment system such as PayPal which is responsible for issuing both types of IDs: stakeholder identities as well as unique transaction (or DCL statement) serial numbers. Clearly, since our goal is to have our system tied to standard government-backed banking, it is convenient to have all stakeholders possess accounts linked to the digital payment system that generates IDs and transaction numbers. The advantages are simplicity and convenience in transaction ID generation, but its disadvantages include a single point of failure and reliance on a single source for trust. Note that computational efficiency is less of a concern because most DCL statements and queries feature a human-in-the-loop that automatically limits the rate at which transactions are likely to be generated. Thus, the maximum computational capacity needed is no worse than at any major ecommerce website.

The second approach is a slight variation: each stakeholder is affiliated to some bank or credit card account, and these are at mutually-distrusting financial entities. These financial entities are responsible for issuing IDs. This has the advantages, again, of tying the proposed system to regular banking but, through multiple banks that audit each other, can address both issues: single point of failure and single source of trust.

In both the first and second approaches, we assume that banks will post to the distributed ledger every request for an ID. For donors that do not wish to be identified, the IDs anonymize the donor but can be “opened” via public-key cryptography in case of a legal challenge. We note that one compelling advantage of using standard banks is that they combine four useful features for the stakeholders: (1) the banks are already legally bound to operate under audit; (2) they have an incentive to be efficient since they benefit from the transaction flow; (3) the banks can serve as a policing function by blocking malicious parties from gaming the system; (4) and perhaps the most important one is that banks have the legal authority to authenticate stakeholders as individuals and as organizations based on their physical tax identifiers. This last one is critical in preventing denial-of-service or flooding attacks that create multiple fake identities.

2) Queries for donors and donor aggregators: We envision the following common scenarios for donors. Donors should have the ability to: (1) search existing proposals, projects and recipients; (2) make isolated donations with constraints and reporting requirements; (3) issue continued donations spread over time; (4) stimulate or join matched contributions; (5) rate a recipient aggregator; (6) receive reports on their spending; (7) perform validation by operating a server in the ecosystem.

Let us walk through the steps with a simple example of a donor that wishes to make a monthly donation for a year for either food or clothing. The donor first uses their account with the central digital bank to convert actual currency into a token that can be sent with the DCL statement into the public ledger. The DCL statement includes the user's ID and is carried inside a transaction message described below. The message header contains various IDs that tie the DCL query to the originator and the bank that created the transaction IDs.

FROM ANON (USERID=VO8t05RV9NrZYtrT1wL4QLcjp) TIMESTAMP 2018-02-12T20:53:00+00:00:00001 DONATE $100 MONTHLY Mar. 10, 2017 TO Mar. 10, 2018 DECIDE FCFS WHERE (SCHEMA=1.1) AND ((CATEGORY=food) OR (CATEGORY=clothing)) REPORT ONCE

Here, we see that a donor who wishes to be anonymous is donating $100per month over the period of a year, with the stated aim of allocating the funds on a first-come-first served (FCFS) basis in the categories of food and clothing. The schema refers to the product ontology that is being applied (for which options include schema.org and other such ontologies [11], [10], [12]). The donor also seeks a single report at the end of spending. Next, we see that the bank issues both a timestamp that's sufficient to serialize such statements, and an encrypted token to be used as the reference so that later, when donation is paired with a charity, the charity can use the token to reference this donation. Finally the bank also includes a signed digest to detect whether the statement itself has been tampered with. The statement is then written to the public distributed ledger, awaiting further action when a node in the system performs pairing as part of writing the next block in the blockchain.

Eventually, when algorithmic pairing occurs, such “buy orders”are paired with projects or recipients and eventually spent, with a report that aggregates over time using the token reference number so that it can be returned to the donor.

A simpler version allows a donor or a representative to query the system for existing projects that might suit their interests, as in: Query existing proposals:

FROM PSEUDONYM NightHawk (ID= . . . ) FIND PROJECTS WHERE (SCHEMA=1.1) AND (CATEGORY=food) OR (CATEGORY=clothing)

Since these carry no obligation, no security measures are necessary and hence are not wrapped into a transaction message. A donor may wish to change the DECIDE clause by seeking to match existing contributions: DECIDE MATCH name= . . . names a particular pseudonym whereas leaving the name out results in the first match that meets all the criteria. Thus, a matching contribution merely adds the requirement that another contribution has already been made of at least the same amount. And, a donor can issue a rating, as in:

FROM ANON (ID= . . . ) RATE Bright Ray Charity AS 4.3/5

Finally, a donation statement whose conditions are not satisfied or which has expired will eventually be returned to the donor, at which tinge they could reconsider some of the conditions. 3) Queries from recipient aggregators: One of the most important features in enabling algorithmic pairing is to allow recipient aggregators to create a statement of intent—that is, to define a project. Here is an example:

FROM Bright Ray Charity (ID= . . . ) DEFINE PROJECT Food Drive 2018 GOAL $10,000 WHERE (SCHEMA=1.1) AND (CATEGORY=food)

Clearly, this is a project that can be paired with the donation example from above. Here is an example of issuing a call to vendors for a particular food item:

FROM Bright Ray Charity (ID= . . . ) DEFINE PROJECT Food Drive 2018 GOAL $10,000 WHERE (SCHEMA=1.1) AND (CATEGORY=food)

Note the use of a hierarchical ontology (in Schema 1.1). Recipient aggregators may also query existing donations in the ledger, rate vendors, and are expected to report on their spending as in:

FROM Bright Ray Charity (ID= . . . ) EXPENSE=$550.00 TO VENDOR Fresh House Grocery WHERE (SCHEMA=1.1) AND PROJECT=Food Drive 2018 AND (CATEGORY=food.canned.soup)

Once a vendor verifies this by posting a receipt to the ledger, such a claim can be verified. The more verified claims that a charity has, the higher its rating. 4) Queries from vendors: A vendor needs to be able to query existing calls, make bids, and rate recipient aggregators. As an example of making a bid, consider:

FROM Fresh House Grocery (ID= . . . ) BID $550 TO Bright Ray Charity WHERE (SCHEMA=1.1) AND PROJECT=Food Drive 2018 AND (CATEGORY=food.canned.soup) DESC URL http://fhg/search.html?prodid=98735

Then, it is up to a recipient to accept the bid and complete the transaction. A completed transaction then results in the vendor posting the receipt on the ledger.

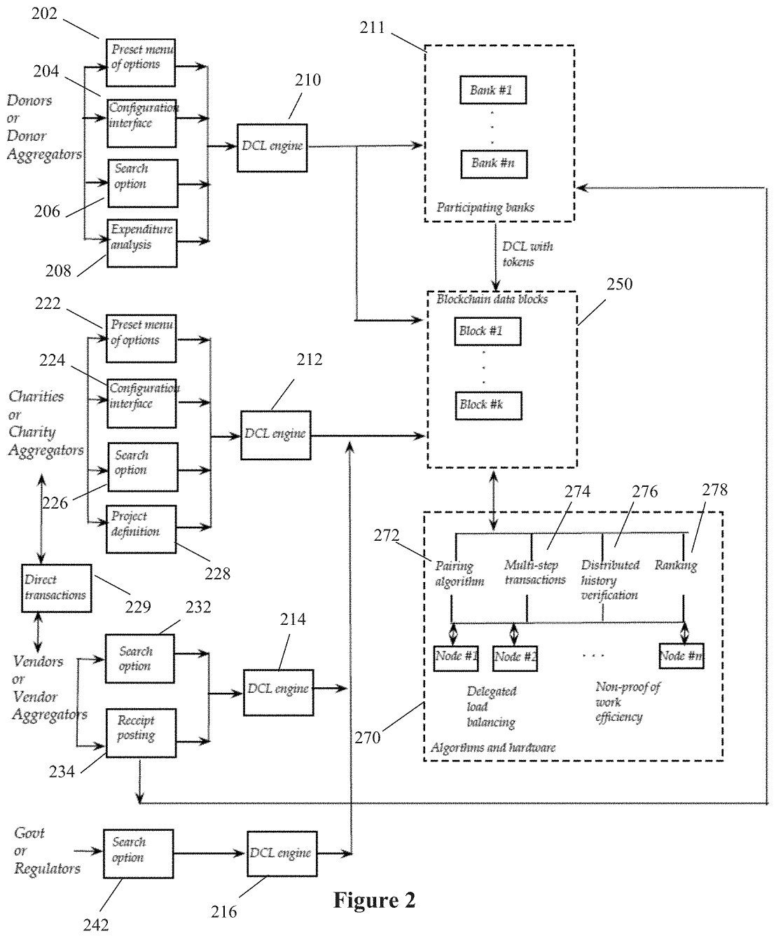

FIG. 2 shows a more in-depth diagram of the entities involved in the blockchain in accordance with an embodiment of the invention. As shown in the diagram, donors or donor aggregators interact with a user interface that offers a number of software modules. The user interface may be comprised of a preset menu of options 202, a configuration interface 204, search options 206, and an expenditure analysis 208. The user interface and its modules provide a connection for the donors to their DCL engine 210. The preset menu of options 202 provides with standardized donation options. The configuration interface 204 provides the donors with the ability to further customize their donation options, for example, by selecting for particular types of charitable organizations or setting minimum/maximum limits on donations. The search options 206 module allows the donors to search for specific organizations or causes, but may include any searches functionalities to query the network known in the art. The expenditure analysis 208 module assists the donors in keeping track of donations and charitable organizations that have received funds from the donor, such that the donors can tabulate their contributions in real-time. As explained with respect to FIG. 1, the donors submit donation offers into a DCL engine 210. The DCL engine creates queries which serve two purposes, create transactions and search transactions.

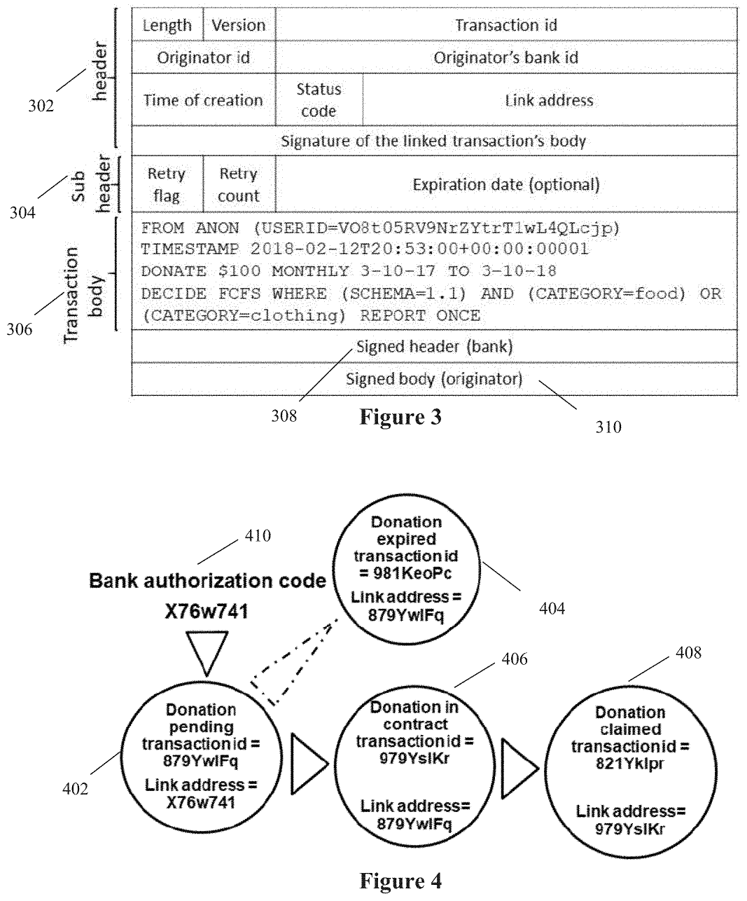

The request from donors travels through the DCL engine 210 to participating banks 211, which process the requests from the donors into blockchain data blocks 250. Processing of the requests into such blocks is explained in more detail with respect to FIGS. 3 and 4 herein.

On the other side of the donor requests are the charities or charity aggregators and the vendors or vendor aggregators previously described with respect to FIG. 1. Similarly to the donor side of the system, the charities interact with the system through a user interface that may be comprised of a preset menu of options 222, a configuration interface 224, search options 226, and a project definition 228 module. The user interface and its modules provide a connection for the charities to their DCL engine 212. The preset menu of options 222 provides with standardized options for receiving donations. The configuration interface 224 provides the charities with the ability to further customize their options, for example, by selecting for particular types of donors or setting minimum/maximum limits on donations. The search options 226 module allows the charities to search for specific donors or like-minded charities, but may include any searches functionalities to query the network known in the art. The project definition 228 module allows the charities to set parameters for the project to be funded, such that the search options 206 used by donors can locate those projects.

The vendors or vendor aggregators are entities that may be involved in direct transactions 229 with charities. Those vendors have similar access to the system through their own interface, which may be comprised of a search options 232 module and a receipt posting 234 module. The user interface and its modules provide a connection for the vendors to their DCL engine 214. The search options 232 module allows the vendors to search for open projects on which they can bid, while also providing any search functionalities to query the network known in the art. The receipt posting 234 module accepts receipts associated with charities and allows stakeholders to keep track of vendor charges.

The government or regulators also may have access to the system of the present invention. The government can use an interface comprised of a search options 242 module that connects to the network through the government's DCL engine 216 to track and monitor transactions in the network, providing accountability and auditing capabilities, and easing tasks such as tracking taxable and non-taxable transactions.

Once requests for funds and donation offers enter the network through the DCL engines 210, 212, the participating banks 211 process them into blockchain data blocks 250, as is further explained below. A number of algorithms 270 are then applied to efficiently match requests for funds from charities with donation offers. Algorithms 270 applied may include a pairing algorithm 272 (explained below), multi-step transactions processing 274, distributed history verification 276, and a consideration of ranking criteria 278, which accounts for the preferences of the stakeholders in donating and receiving funds.

The present invention utilizes blockchain technology as will be explained with reference to FIG. 3, which is a diagram of a single block of data in the chain.

A client-side code executing on the web-browser will send its input to a code that executes on the charity aggregator's web server (i.e., processing device) or its associated computational systems (commonly known as the backend). The webserver and the associated backend might execute in any computing device in a data center or it may be a standalone unit such as a computer, laptop or other such system within the Information Technology infrastructure maintained by the charity aggregator. The server-side code will authorize availability of funds from the donor's bank. This is merely an escrow authorization process which allows the bank to hold the funds in a separate account. It becomes available only when the donation is assigned, and the funds are subsequently claimed by a goods or service provide. These authorizations may be executed as a batch every hour or end of day as appropriate. The escrow authorization process will execute on the bank's authorization system which is again a computation system (server) executing in a datacenter or other Information Technology infrastructure maintained by the bank. The inputs for authorization will be securely provided through the charity aggregator's system. It will send a “Donation Pending” transaction to the blockchain. FIG. 3 shows the structure of each donor transaction.

The single block of data shown in FIG. 3 is typically comprised of a header 302, a sub-header 304, a transaction body 306, a signed header 308, and a signed body 310. The header may be comprised of such data as the length of the block, version of the software used, the block originator's ID, the originator's bank ID, the time of creation for the block, the status code signifying the transaction's status (i.e. pending/completed), and the signature of the linked transaction's body, which matches the header 304 and to its transaction body 306. The block also has a sub-header 304, which is comprised of a retry flag, which is triggered when the block cannot be added to the chain on the first attempt, and a retry count, which keeps track of attempts to add the block to the chain. The sub-header 304 may also optionally include an expiration date, which dictates when that particular block will expire and is no longer eligible to be added to the chain. The transaction body 306 is comprised of the transaction details to be added to the chain. The signed header 308 is attached to the block by the bank, while the signed body 310 is attached to the block by the originator a donor). Both are used in the network for identification and verification of the block.

The blockchain itself executes in a set of computing systems which may be distributed across the globe, in data centers or standalone computing systems within the Information Technology infrastructures of charities, donors, vendors and banks who participate in the governance of the blockchain.

Similarly, a charity visits the charity aggregator. Examples of websites that currently aggregate charities are GoFundMe and DonorsChoose. A representative from a charity writes a project description and may choose categories and other options from the web interface provided by the aggregator's website. The representative's web browser runs a client-side code that takes all inputs from editable fields and sends them to the server-side code that runs on the webserver which gets routed to a classification system that runs on a computation system connected to the webserver (commonly known as the server's backend). The classification system extracts labels from the project description to detect with which, out of the currently serviceable, categories and subcategories the description has the most affiliation. Following the classification process, the system constructs a query similar to the one illustrated earlier and shown below. For example:

### FROM Bright Ray Charity (ID= . . . ) DEFINE PROJECT GIRLSED

### 2018 GOAL $10,000 WHERE (SCHEMA=1.1) AND (CATEGORY=EDUCATION AND SUBCATEGORY=K-12 AND SUBCATEGORY=FEMALE)

The server-side code will send this query to a blockchain node where a pairing algorithm will be executed to match the project or recipient to the donor's criteria. This algorithm's objective is to ensure some degree of spread amongst multiple competing projects that satisfy the criteria. As we see in our illustration, the donor's wish might be represented as multiple decision trees joined together using an OR logic. The following steps of the pairing algorithm will execute on each one of these trees:

(1) Given a donor query, C is the category at the topmost level

(2) Search in the list of charity projects to find those that match the category C. Place the resulting matches in a superset S

(3) From S, filter projects that match with the first sub-category placed under the selected category C. Place these projects in a subset s. Repeat this step for the entire path from the root node to the leaf.

(4) If there are matching projects in the final set, allocate funds to them. Send a transaction, for each matched project that will receive funds, to the blockchain indicating it as “Donation under Contract”

(5) If there are more funds available, repeat the steps 1 to 5 for the next decision tree representation of the donor's query.

The above exemplary algorithm differs from a typical Gale-Shipley (GS) algorithm in a number of ways. For example, unlike the GS algorithm, the preferences is binary: either a project satisfies the criteria or not. The GS algorithm, on the other hand, uses ranks to select pairing. Additionally, unlike the GS algorithm, it will almost never be the case that M=N, some items will not receive a pairing, some donations will fund multiple projects and some projects will be funded by multiple donations i.e., the pairing from M to N is many to many.

### Distributed-Ledger and Consensus

A ledger entry is merely a DCL statement secured by standard cryptographic means into a transaction. Once a transaction containing a DCL statement is in a resolved block of the ledger it will also have a serial number so that all resolved DCL statements are uniquely ordered, as are the larger blocks in which they are contained. This is the purpose of operating a blockchain: to achieve distributed consensus by offering participation incentives and yet prevent domination by any one player.

Any registered stakeholder (with an account with a central bank) can operate a computational node in the permissioned distributed ledger system. We assume that regulators already have an incentive to become nodes. We describe below an incentive mechanism for aggregators and vendors to participate.

Since DCL statements (ledger entries) flow into various nodes in the system, there needs to be a way to organize the serialization and resolution of blocks into the blockchain. Our approach is to combine a leader-based consensus mechanism (such as RAFT [13]), with incentives to spread the leadership capability and prevent any one node from dominating as leader. In particular:
Each node in the consensus system receives ledger entries from anyone and can generate ledger entries.
A node broadcasts its ledger entries to the current consensus leader who follows an acknowledgement based protocol to enable fault tolerance.
A leader is elected as in the RAFT algorithm and any secure voting process such as [14][15] can be utilized.
Only a leader has the authority to resolve the next block through a sequence of computations to: (1) determine the potential ledger entries in the current block; (2) compute pairing if needed; (3) hash and sign the block; (4) verify P previous blocks (where P is a system parameter); (5) broadcast the current block.
The resolution of the next block triggers a new leader election (to prevent domination). Also, the current leader is ineligible to become the next leader in the next L rounds of leader elections. Here, L is a parameter of the system.
Leader elections are also triggered by timeouts so that no leader can deny service by merely blocking further action.
After the next leader is elected, the previous leader finalizes the block by adding a signed ledger entry that contains the next leader's ID as well as the votes affirming the election of the leader.
A leader's reward is based on the number of ledger entries processed (to maximize processing as many entries as possible), weighted by the age of each transactions (to prevent an entry from being left behind).

When a leader resolves a block, it is awarded a participation point. These participation points accumulate as an incentive. We propose two alternatives. One is for the central bank to charge a tiny fee for each actual transaction and to let that fee accumulate into a fund used to reward aggregators or vendors who have accumulated sufficient points. Another approach is to allow the points generated to be incorporated into the ratings of aggregators and vendors so that they compete for visibility and recognition. In order the further incentivize leaders, the reward for making a block is in proportion to the number of ledger entries in the block.

### Algorithmic Pairing

The purpose of algorithmic pairing is to find a suitable project or recipient according to the donor's criteria. A secondary goal is to ensure some degree of spread amongst multiple competing projects that satisfy the criteria. Finally, we also wish to design a system that is robust to gaming or attacks.

Our approach is to use a variation of the classic Gale-Shapley algorithm for the stable marriage problem [16]. In the most basic version of the problem, there are M type-A items to be paired with N type-B items (most often M=N), where each item ranks every member of the other type. Under certain conditions, a simple algorithm provides a stable “marriage.” Much research has gone into variations as well as attempts to make the resulting allocation fair to both sides [16]. In our case, we can choose the donations as type A, and potential recipients or projects as type B. However, we need a variation that must account for the following:
In our case, preferences are often binary: either a project satisfies the criteria or not. Thus, to decide amongst equivalently satisfying projects, the projects can be randomized before selecting the next one. For transparency, the method of randomization and the particular choice made would need be made public and written back into the ledger. A simple way to achieve this is to use a known algorithm (such as a Lehmer generator) where the seed uses a combination of the timestamp of the last ledger entry in the most recently resolved block and that block's hash. This way, the sequence is reasonably unpredictable yet verifiable.
It will almost never be the case that M=N and so some items will not receive a pairing and will have to “wait.” Also, it is equally probable that the current set of donations are not sufficient to meet the goal of a particular project, and thus, the difference will remain to be fulfilled. Thus, the pairing algorithm will need to go as far back as needed in the blockchain to find incompletely-satisfied projects.
It should be possible to prioritize projects that are either very early of have received very little so that no project remains unlucky for too long or is totally unfunded.
Finally, donations can also specify that rankings should be used, in which case, there is a natural preference order. However, to prevent a few aggregators from dominating, some randomness can be inserted to enable spreading the wealth.

### Reporting and Donor Interfaces

One of the computational tasks of a leader is to aggregate expenditure data for donors. Here, the algorithm is simple: examine posted receipts, find the originating transactions and post reports to the ledger, one for each donor whose funds were used towards a receipt. Thus, at any given time, a donor might have a list of such report entries awaiting them. Donors can retrieve reports by signing on to the system through which they originally sent the pledge.

### Validation and Challenge

A third computational task for any leader, beyond pairing and reporting, is to cross-check the entries written by other leaders. This feature is at the heart of public verifiability, so that any leader who games the system or even makes a mistake is identified, followed by appropriate corrective action.

We propose that each leader checks P randomly selected previous blocks and includes a ledger entry in the block it generates stating the block IDs that were checked. To reduce the burden on checking and to ensure all blocks are checked by a majority of leaders, we propose that any block that has been checked by sufficient number of leaders is considered “retired” and does not need to be checked anymore. What happens when an inconsistency is discovered? It is tempting to try and design an automated way to “undo” a resolved block and reresolve the block following an inconsistency. However, this may lead to catastrophic consequences (actual expenditures) that are difficult to roll back. Instead, we propose that any inconsistency is reported in the next block through a ledger entry and it is escalated to human intervention, through a steering committee or governing board. If the penalty is severe enough (denial of participation for a year, for example), there is little incentive for legitimate entities to cheat.

### Security

We present our threat model and specific details that allow for building a system that is robust to the given threat.

1) An adversary might remove or change a donation
2) A donor might go back on a pledge
3) A bank might withhold funds
4) A vendor might use the same receipt to claim money from multiple donations (double claim).
5) Denial of service by the consensus leader i.e., suppressing a DCL query or activity.
6) Duplicate malicious leader sending spoofed blocks, or deploying multiple servers to win an election (Sybil attack).

In order to thwart the above threats, we define the system's transaction design and the process of maintaining consistency. We reflect back on the threats to explain how the design removes the risks posed by the above threats.

### Transaction Structure

We propose the following structure for a transaction in our system, shown in FIG. 2. First each transaction has a header that consists of the header length field, version number, transaction id, originator id, originator's bank id, time of creation, status code, link address and the signature of the transaction that this transaction links. There is a sub header containing retry flag, a retry count and an optional expiration date to deal with retransmission of a ledger entry when needed for fault tolerance. Following this, the transaction body consist of the contents of the DCL statement. Finally, the transaction header signed by the bank and the header and body signed by the originator are attached to the transaction. We represent a transaction with the following notation: Tₐ(hᵢ, tidᵢ) where a is the originator id and tidᵢ is the i transaction id and hi is the header associated with the transaction. The digitally signed hash of the transaction is represented as E(Kₐ,H(Tₐ(hᵢ, tidᵢ))) and the header alone is signed as E(K_{b}; H(hᵢ)) by the originator's bank. Having this structure helps us maintain the data that is needed to thwart each one of the threats mentioned above.

### Types of Transactions

As shown in FIG. 4, there are four types of transactions, Donation Pending (P) 402, Donation Expired (E) 404, Donation in Contract (C) 406, and Donation Claimed (D) 408. When a donor makes a pledge, the Donation Pending 402 transaction is created which appears as a pending payment against the credit card or bank account. These funds remain in a pending state until the donation expires or Donation Claimed 408 transactions are created. The link address field in the Donation Pending 402 transaction is set to the bank's transaction authorization code 410 and the signature is the signed hash of the authorization code. This creates a link between the digital currency and an actual bank authorization binding both the donor and the bank into honoring the pledge. The header field ‘link address’ and ‘signature of linked transaction’ in the Donation under Contract transaction 406 is set to the Donation Pending 402 transaction id and signature that of the Donation Claimed 408 contains Donation under Contract's 406 transaction id and signature. The Donation Expired 404 transaction carries the Donation Pending 402 transaction id and signature in its link address and signature fields. This information ties each transaction directly and immutably with the original donation and each transaction header is immutably tied to the transaction body.

### Transaction Chaining and Consensus

A chained Merkel root based ledger structure similar to that of Bitcoin is utilized in an embodiment of the invention. Thus lets say a transaction Tₐ(hi, status, tidᵢ) is generated by an originator a. Then Tₐ(hᵢ, status, tidᵢ)∥E(K_{b},H(hᵢ))∥E(Kₐ,H(Tₐ(hᵢ, status, tidᵢ))) is sent as a ledger entry to the consensus network. A participant q in the blockchain consensus process, sends the ledger entry to the current consensus leader. The leader constructs a block as a Merkle tree composed of all ledger entries that were received during a block generation period §. In addition, the Merkle tree of block Bᵢ consists of the Merkle root of Bᵢ₋₁ signed by the creator r of block B(i-1). Thus B(i-1)∥E(Kᵣ,H(B(i-1))) becomes the leftmost leaf in the block B(i). We do not believe that a proof-of-work like blockchain is sustainable in this scenario. Therefore, as explained earlier, we use a leader-based distributed consensus algorithm with sufficient additions to ensure proper functioning in the presence of malicious participants in the system Participants in the consensus system might be charities, aggregators and vendors who have a vested interest in maintaining an honest and verifiable chain.

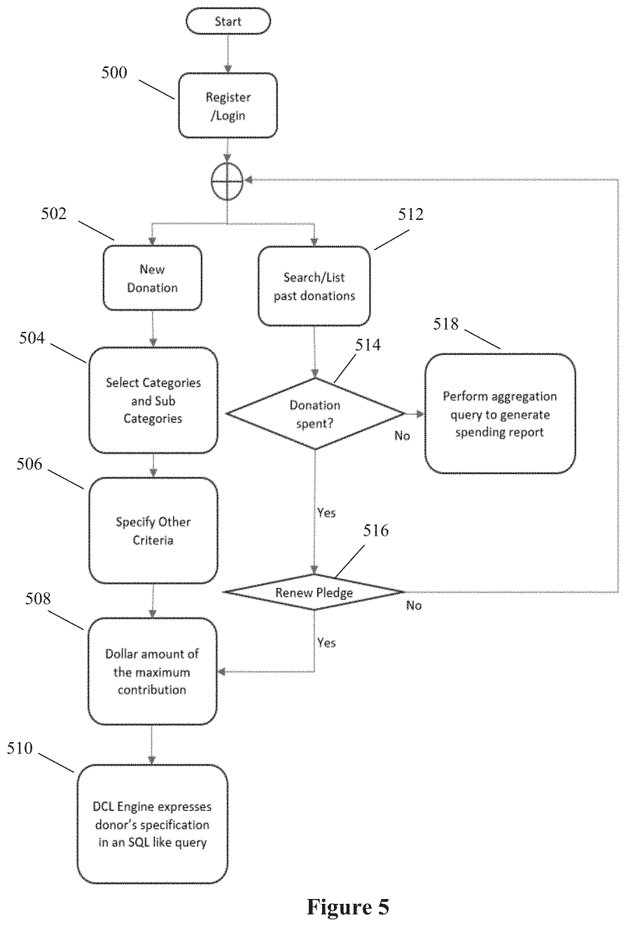

FIG. 5 is a diagram outlining a method by which the DCL engine processes a transaction in accordance with an embodiment of the invention. More specifically, FIG. 5 shows how a donor may interact with the system. A typical interaction starts at the login screen, “Register/Login” 500, where the donor logs into the system or registers for access. The donor can then prepare to make a new donation at “New Donation” 502. The software of the present invention then allows the donor to select categories or sub-categories for the donation at “Select Categories and Sub Categories” 504. The donor may also specify any other criteria for the donation (i.e. type of charity, cause) at “Specify Other Criteria” 506. The software then allows the donor to select the dollar amount of the donation at “Dollar Amount of the Maximum Donation” 508. The data provided by the donor is then submitted to the DCL engine at “DCL Engine Expresses the Donor's Specification in an SQL Like Query” 510, at which point the DCL engine builds a transaction for the donation based on the donor input. That transaction is structured similarly to an SQL query.

In an alternate software path, the donor can search prior donations at “Search/List Past Donations” 512. From there, the software allows the donor to see if the donation was used at “Donation Spent?” 514. If the donation was not spent, the donor can generate a spending report using an aggregation query at “Perform Aggregation Query to Generate Spending Report” 518. If the donation was indeed spent, then the software offers the donor the option to renew the pledge at “Renew Pledge” 516. If the donor chooses to renew, the donor is directed to select the dollar amount of the donation at “Dollar Amount of the Maximum Donation” 508. That data provided by the donor is then submitted to the DCL engine at “DCL Engine Expresses the Donor's Specification in an SQL Like Query” 510, at which point the DCL engine builds a transaction for the donation based on the donor input. If the donor chooses not to renew the pledge, she is returned to the main screen of the interface.

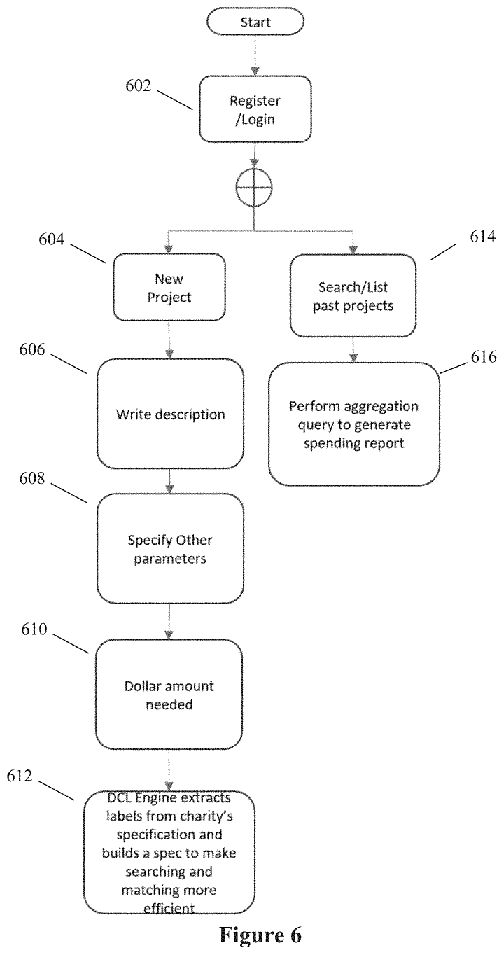

FIG. 6 is a flowchart outlining a method by which the DCL engine builds a specification for a charity in accordance with an embodiment of the invention. More specifically, FIG. 6 shows how a charity may interact with the system. The software pathway commences at the login screen for the interface, “Register/Login” 602, where a charity can register for access to the system or login using preexisting credentials. The charity will then have the choice to create a new project at “New Project” 604, or to search or list out all of its past projects at “Search/List Past Projects” 614. If the charity chooses to create a new project, the charity is prompted to enter information about the project at “Write Description” 606. The charity is then prompted to enter other parameters for the project at “Specify Other Parameters” 608. Parameters could exemplarily be related to the length of the project, the types of donors the charity is searching for, or who the project is intended to benefit. Other parameters can be entered, as will be readily apparent to one of ordinary skill in the art. Following parameter entry, the charity is prompted to enter the dollar amount needed for the project at “Dollar Amount Needed” 610. That data collected from the charity then passes to the DCL engine, which extracts labels from the charity's project data to build a specification that can be sent into the blockchain at “DCL Engine Extracts Labels from Charity's Specification and Builds a Spec to Make Searching and Matching More Efficient” 612. The specification generated by the DCL engine is designed to be compatible with the blockchain network and enable the specification to be easily searched and matched to donations on the blockchain network.

In an alternate software path, the charity can search prior projects at “Search/List Past Projects” 614. From there, the charity can generate a spending report using an aggregation query at “Perform Aggregation Query to Generate Spending Report” 616 to see spending breakdowns on those past projects.

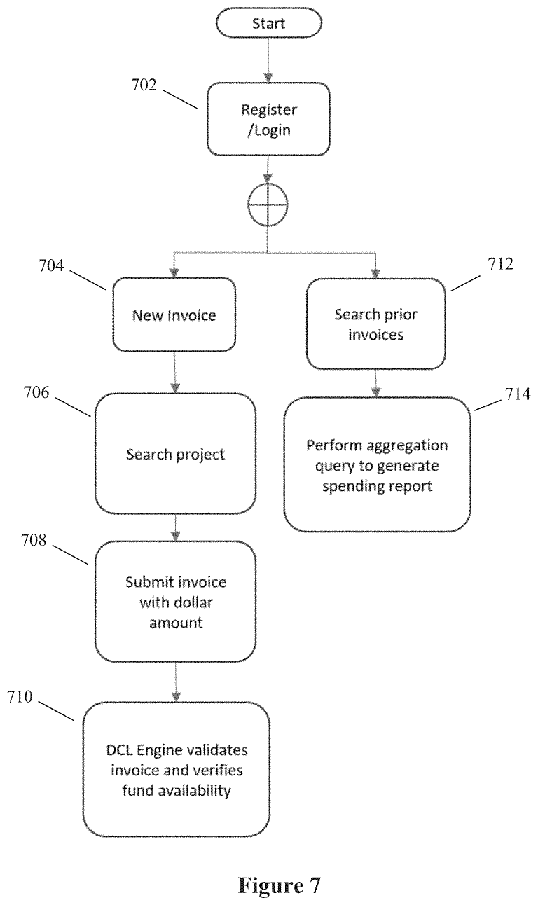

FIG. 7 is a flowchart outlining a method by which the DCL engine validates and verifies fund availability in accordance with an embodiment of the invention. More specifically, FIG. 7 shows how a vendor may interact with the system. The software pathway commences at “Register/Login” 702, where the vendor can register to participate in the system of the present invention or login using preexisting credentials. The vendor is then prompted to create a new invoice at “New Invoice” 704 or to search prior invoices at “Search Prior Invoices” 712. If the vendor chooses to create a new invoice, the software prompts the vendor to search for projects in the system at “Search Project” 706. Once the vendor locates the project that is associated with the invoice to be created, the vendor can enter the invoice details along with the dollar amount at “Submit Invoice with Dollar Amount” 708. That data collected from the vendor is then sent to the DCL engine, which validates the invoice and verifies the availability of funds in the project to pay the invoice. That step is shown at “DCL Engine Validates Invoice and Verifies Fund Availability” 710.

In an alternate software pathway, the vendor is prompted to search prior invoices at “Search Prior Invoices” 712. From there, the vendor can generate a spending report using an aggregation query at “Perform Aggregation Query to Generate Spending Report” 714 to see spending breakdowns on those past projects and how invoices have been paid out on those projects.

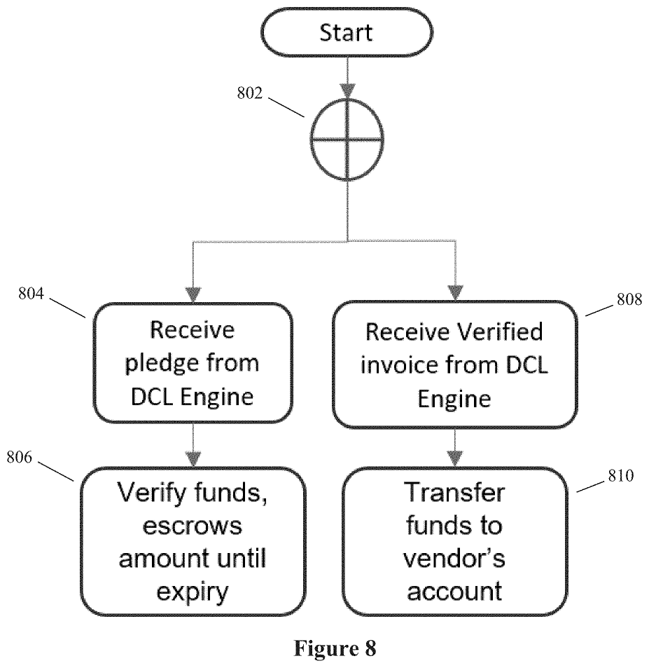

FIG. 8 is a flowchart outlining a method by which a vendor is compensated in accordance with an embodiment of the invention. The software pathway commences at “Start” 802, where the backend of the system receives either a pledge from the DCL engine at “Receive Pledge from DCL Engine” 804 or a verified invoice from a vendor at “Receive Verified Invoice from DCL Engine” 808. When the system backend receives a pledge, it verifies the funds and escrows the amount until the pledge expires, as shown at “Verify Funds, Escrows Amount Until Expiry” 806. Alternately, when the system receives a verified invoice from a vendor, it will transfer funds to the vendor's account in that amount, as shown at “Transfer Funds to Vendor's Account” 810. In this manner, the system mediates transactions on the network.

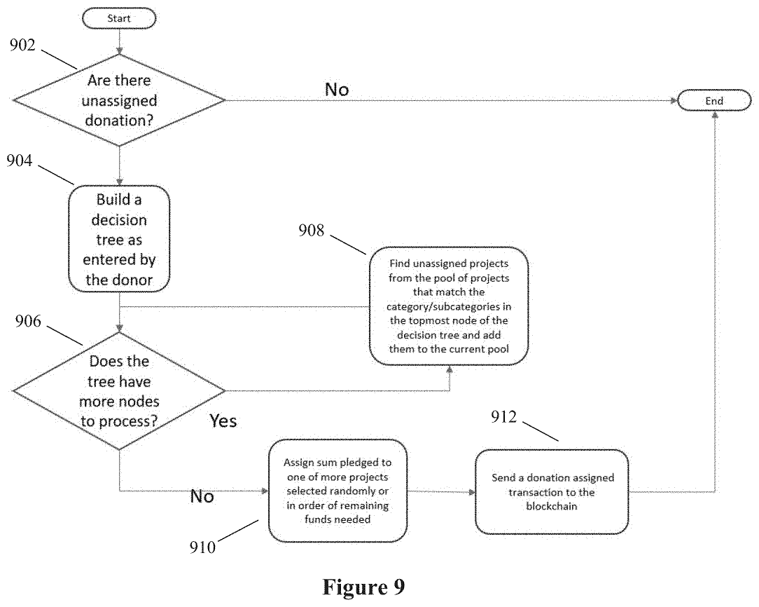

FIG. 9 is a flowchart outlining a method of pairing used in accordance with an embodiment of the invention. The software pathway commences with the software checking the network for unassigned donations at “Are There Unassigned Donations?” 902. If there are not, then the software pathway terminates. However, if there are unassigned donations, the software pathway continues to building a decision tree based on the data entered by a donor when building out a pledge specification, as shown at “Build a Decision Tree as Entered by the Donor” 904. The software pathway then checks the decision tree to see if there are additional nodes to process at “Does the Tree Have More Nodes to Process” 906. If the tree does have additional nodes to process, then the software finds assigned projects from the pool of projects that match the donor specification categories and/or subcategories in the top-most node of the decision tree and adds them to the current pool of projects being considered by the software. That step is shown as “Find Unassigned Projects from the Pool of Projects that Match the Category/Subcategories in the Topmost Node of the Decision Tree and Add them to the Current Pool” 908. The software then returns to step 906 to check whether there are more nodes in the decision tree to process. Once the software determines that there are no more nodes to process, the software assigns funds from the pledge to one or more of the identified projects, either at random or in order, based on the need for remaining funds. That step is shown at “Assign Sum Pledged to One or More Projects Selected Randomly or in Order of Remaining Funds Needed” 910. The software then sends the assigned transaction or transactions to the blockchain to record it and process the fund transfer, as shown at “Send a Donation Assigned Transaction to the Blockchain” 912. The software then terminates.

### Non-Repudiation of Transactions

Each transaction of type P and E is signed by the private key of the donor and the donor's bank as explained before and shown in FIG. 2. The aggregator or charity signs transactions of type C and the vendor signs the Donation Claimed transaction. As in the case of donor generated transactions, their banks sign the headers of these transactions to prevent misuse and spoofing of the transaction IDs. These signatures help us achieve non-repudiation for each stakeholder. The charity and donor may still keep paper trail or electronic evidence of their physical transactions for regular audit and monitoring.

The transactions are structured as components of a linked data structure due to the inclusion of the address of the previous transaction. Thus, a claim transaction can be linked to only one donation in contract transaction. If a project cannot be fulfilled by a single donation, it will need to be broken down into multiple donation contract transactions to bind with different donation pending transactions (similar to real life partial payments when multiple methods of payment are used to pay for an expensive purchase).

Due to the linked structure, an independent validator can easily create an accounting balance sheet of any donation and all claims against it to verify how a donation has been spent.

### Defending Against Threats

The threat of tampering with any transaction is addressed due to inherent integrity properties of the blockchain. Each block consists of the signed Merkle root of the previous block, which makes the chain self-certifiable. The block creator signs the Merkle root of each block it creates. Thus any inconsistencies can be traced back to the participant who constructed a bad block provided the participants in the consensus system remain honest. In order to ensure that a malicious leader did not go back to change or remove ledger entries, each newly elected leader is required to check P previous blocks. The leader certifies this by producing the first ledger entry in the Merkle root which contains the IDs and signed digests of previous P blocks that the current leader has checked. Any block that has been checked by a majority of consensus participants during their tenures as leaders can be “retired” and hence do not need to be checked. Each Merkle root also contains the ID of the leader elected to compute the next block along with the vote that affirmed the leader. This removes the problem of spoofed blocks as the next leader can easily detect the presence of the spoofed block and the network can differentiate between genuine and spoofed blocks since the signature in the spoofed block is not expected to be that of the leader whose ID is embedded in the previous block.

The threat of donor's going back on a pledge is solved through standard banking processes as donors authorize the funds they are committing through their bank or credit-card accounts. In addition, source non-repudiation is achieved due to the donor's and their bank's digital signature accompanying a Donation Pending transaction. The Donation Pending transaction includes the ID of the bank that authorizes the payment as well as the transaction ID that the bank creates. Thus a pending donation can be traced back to the original bank that authorized the transaction and issued a transaction ID. Therefore, the bank is bound by federal regulations and must honor the commitment o release funds when the transaction enters the claimed status.

The vendor signs a Donation Claim transaction and includes the address of the original Donation Pending transaction in the link field of the transaction header. The body of the claimed transaction itself contains the receipt of the delivery of the goods signed by the charity. The recipient bank generates the transaction ID for the Donation Claimed transaction. A vendor would not be able to post fraudulent claims unless they collude with a charity. Through our openly verifiable system, such collusion can be easily detected by someone who knows the ground truth in these transactions, which makes it easy to alert the appropriate law enforcement authority.

### Denial of Service by the Consensus Participants and Leader

We have earlier proposed that the Raft Consensus protocol can be used as an alternative to the expensive proof-based consensus used in crypto-currencies. Leader election in Raft is subject to Sybil attack where a node makes several copies of itself to increase its odds of election. However, since the leader election can itself be based on unique IDs of candidates and voters, even if a node mounts a Sybil attack, only one of the Sybil nodes will succeed in posing as a candidate and only one vote can be casted by a voter ID. Furthermore, a leader must wait L rounds, which also mitigates the Sybil attack. Denial of service is another threat that is inherent to a leader-based consensus mechanism In computer networking protocols, a standard and perhaps the only way to provide reliable two way communication is to retry a failed message. We will also follow a protocol based approach to this threat which illustrate in the following steps:

1) A donor or stakeholder S sends a DCL query to any mother consensus participant Cⱼ.
2) Cⱼ must generate a ledger entry and pass it to the leader Lᵢ. Lᵢ must acknowledge receipt of the entry with a return message that contains sufficient information and cryptographic protection so that it can be uniquely tied to the original ledger entry.
3) Cⱼ logs the acknowledgment as proof that the query was received by Lᵢ, waits for a block generation period and then queries the blockchain to ensure that the transaction has been entered in the block.
4) If Cⱼ does not receive an acknowledgement, it increments the retry count field in the transaction header, sets the retry flag to true, and sends the transaction again.
5) The above step may be repeated until a maximum number of retries have failed or a successful acknowledgement is received.
6) If Cⱼ fails to receive the acknowledgement after the maximum number of attempts, it can send the ledger entry to the next leader. At this point, flag is set to 1 and retry count s reset to 0.
7) If after receiving the acknowledgement, Cⱼ does not find the transaction in the next block that was created, it would follow up by sending the acknowledgement and the transaction to the next leader. If the donor or stakeholder fails to find the DCL in the block, it can try to send the query to another consensus participant.

The above protocol steps enable senders by generating sufficient proofs that their transactions were acknowledged. They can be extended to allow the consensus participants to build a blacklist of malicious or faulty nodes in the network.

### Pairing Algorithm

The pairing algorithm works as follows. First the conditions of each donation is organized as a decision tree. Then starting from the root of the tree, the nodes of the tree are processed in order to find matching projects. First the superset of projects that match the root node is created. This superset is iteratively refined by eliminating based on sub-categories. Finally, once a tree leaf is reached, one of more projects are selected from the refined set. These projects are funded through the donor's pledge. If there is more money left in the pledge, remaining unexplored branches of the tree may be processed in the same fashion until all of the pledged sum is assigned.

The end-to-end process can be explained through an example. This example assumes that the donor would like to fund projects that provide education or healthcare. These are broad categories and the donor can provide more specific instructions to narrow the scope. Suppose for education, the donor selects K-12 education for girls or early education for all. The donor also chooses in-home healthcare for seniors or hospice care for the disabled. Further, the donor is pledging $100 per month, selects projects in first come first serve order (i.e. chronologically) and requests one report once a project is funded.

The donor can express their wish and make a pledge at a website hosted by any participating donor aggregator. The website provides an interface where the donor can choose categories and options. The websites may use static drop-down menus from which the donor can make selections, a query is created using client-side code that runs on the web browser on the donor's computer. This query will be built as follows.

### FROM ANON (USERID=VO8t05RV9NrZYtrT1wL4QLcjp)

### TIMESTAMP 2018-02-12T20:53:00+00:00:00001 DONATE $100

### MONTHLY Mar. 10, 2017 TO Mar. 10, 2018 DECIDE FCFS WHERE (SCHEMA=1.1)

### AND (((CATEGORY=EDUCATION AND ((SUBCATEGORY=K-12 OR SUBCATEGORY=EARLY_LEARNING)

### AND SUBCATEGORY=FEMALE)) OR (CATEGORY=HEALTHCARE AND ((SUBCATEGORY=SENIORS

### AND SUBCATEGORY=HOMECARE) OR (SUBCATEGORY=CHAILENGED AND

### SUBCATEGORY=HOSPICE))) AND REPORT ONCE

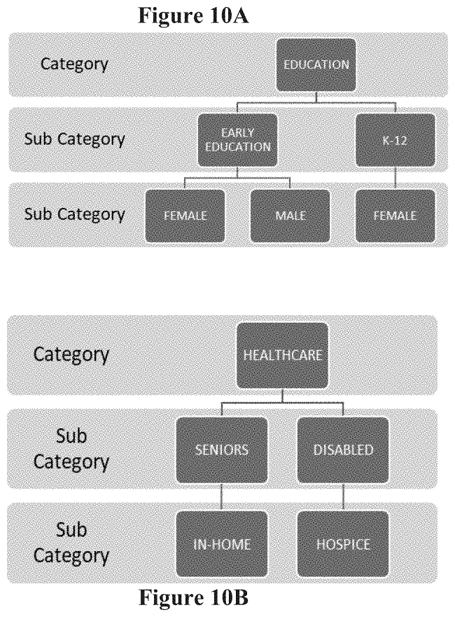

This can also be represented as the two decision trees shown in FIGS. 10A and 10B. FIG. 10A is diagram showing an exemplary breakdown of the “Education” category for charitable donations. FIG. 10B is a diagram showing an exemplary breakdown of the “Healthcare” category for charitable donations.

In the decision tree shown in FIG. 10A, the category, “Education,” is broken down into exemplary subcategories. As shown, “Education” can be broken down by the system into “Early Education” and “K-12” “Early Education” can then be subcategorized into “Female” and “Male.” Similarly, “K-12” can be subcategorized into “Female” and “Male” (not shown).

In the decision tree shown in FIG. 10B, the category, “Healthcare,” is broken down into “Senior” and “Disabled” subcategories. The “Seniors” category can then be subcategorized as “In-Home,” while “Disabled” can be further subcategorized as “Hospice.” As explained above, the categorization is used by donors to select how to direct their pledges.

### Conclusions

Herein is explained how blockchain technology can be adapted for the realm of charitable donations and social entrepreneurship. Instead of a proof-of-work approach, we use a well-known leader based consensus scheme from distributed computing, with the addition of incentives to participate in block creation. We propose algorithmic pairing to give donors more control over how their money is used and to ease the burden of searching for best matches to their intentions. It has the potential to reduce the human bias noted by others, gives better access to funds to smaller organizations and NGOs, and reduces the outsize power currently held by foundations and big charitable organizations. Most importantly, the features of the system promote social good through incentives for transparency, accountability and participation.

The system and method of the present invention include operation by one or more processing devices, including the DCL engines 210, 212, 214, 216, donors 201, charities 222, vendors, gov't, pairing 270, and blockchain 250. It is noted that the processing device can be any suitable device, such as a computer, server, mainframe, processor, microprocessor, PC, tablet, smartphone, or the like. The processing devices can be used in combination with other suitable components, such as a display device (monitor, LED screen, digital screen, etc.), memory or storage device, input device (touchscreen, keyboard, pointing device such as a mouse), wireless module (for RF, Bluetooth, infrared, WiFi, etc.). The information may be stored on a computer hard drive, on a CD ROM disk or on any other appropriate data storage device, which can be located at or in communication with the processing device. The entire process is conducted automatically by the processing device, and without any manual interaction. Accordingly, unless indicated otherwise the process can occur substantially in real-time without any delays or manual action.

The foregoing description and drawings should be considered as illustrative only of the principles of the invention. The invention may be configured in a variety of shapes and sizes and is not intended to be limited by the embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

The following references are hereby incorporated by reference. [1] In'es Alegre and Melina Moleskis. Crowdfunding: A review and research agenda. 2016. [2] Lise Vesterlund. Why do people give. The nonprofit sector: A research handbook, 2:168-190, 2006. [3] Christian Cachin. Architecture of the hyperledger blockchain fabric. In Workshop on Distributed Cryptocurrencies and Consensus Ledgers, 2016. [4] Pablo Lamela Seijas, Simon J Thompson, and Darryl McAdams. Scripting smart contracts for distributed ledger technology. IACR Cryptology ePrint Archive, 2016:1156, 2016. [5] Quinn DuPont. Experiments in algorithmic governance: A history and ethnography of the dao, a failed decentralized autonomous organization. Bitcoin and Beyond: Cryptocurrencies, Blockchains and Global Governance. Routledge, 2017. [6] R. Dietz and B. Keller. Donor loyalty study: A deep dive into donor behaviors and attitudes. Nonprofit Times, 2016. [7] A. Butcher. What donors want when it comes to communication. Nonprofit Quarterly, September 2015. [8] Root Cause. Informed giving: information donors want and how nonprofits can provide it. Root Cause, Boston, Mass. http://www.rootcause.org/docs/Blog/Informed Giving Full Report. pdf, 2013. [9] Simon McGrath. Giving donors good reason to give again. International Journal of Nonprofit and Voluntary Sector Marketing, 2(2):125-135, 1997. [10] T. D. Wang, B. Parsia, and J. Hendler. A survey of the web ontology landscape. The Semantic Web—ISWC 2006. Lecture Notes in Computer Science, 2006. [11] Dan Brickley and R V Guha, Rdf schema. W3C, 2014. [12] Martin Hepp. Good relations: An ontology for describing products and services offers on the web. In Proceedings of the 16th International Conference on Knowledge Engineering and Knowledge Management (EKAW2008), Acitrezza, Italy, 2008. [13] Diego Ongaro and John K Ousterhout. In search of an understandable consensus algorithm. In USENIX Annual Technical Conference, pages 305-319, 2014. [14] Valerie King, Jared Saia, Vishal Sanwalani, and Erik Vee. Towards secure and scalable computation in peer-to-peer networks. In Foundations of Computer Science, 2006. FOCS'06. 47th Annual IEEE Symposium on, pages 87-98. IEEE, 2006. [15] Kazuo Iwama and Shuichi Miyazaki. A survey of the stable marriage problem and its variants. in Informatics Education and Research for Knowledge-Circulating Society, 2008. ICKS 2008. International Conference on, pages 131-136. IEEE, 2008. [16] Rahul Simha. Directed cash: A distributed ledger for charitable donations. Whitepaper, Department of Computer Science, George Washington University, 2016.

1. A computerized method for allocating resources comprising:
receiving a plurality of offers for resources;
transmitting the offers for resources to a blockchain network, wherein the offers for resources is structured as a first set of transaction requests;
constructing a request for resources;
transmitting the requests for resources to the blockchain network, wherein the requests for resources are structured as second set of transaction requests;
applying a pairing algorithm to match each of the offers for resources to one or more of the requests for resources, wherein the algorithm comprises using a binary, iterative decision tree to match each of the offers for resources to one or more of the requests for resources, wherein the matched offers and requests are each recorded to a blockchain as a block, wherein each block of the blockchain is comprised of a header, a subheader, a signed header from a bank, and a signed body.

2. The method of claim 1, wherein the offers for resources are a donation to a charity.

3. The method of claim 1, wherein the offers for resources are structured as an SQL-like query.

4. The method of claim 1, wherein the requests for resources are comprised of one or more parameters to build a specification.

5. The method of claim 4, further comprising extracting labels from the requests for resources' specifications, wherein said labels are used to match the request for resources to the offer for resources.

6. The method of claim 1, further comprising verifying and recording vendor invoices to the blockchain.

7. The method of claim 1, wherein the decision tree is comprised of one or more nodes, wherein the nodes are comprised of categories for allocating the offers for resources.

8. The method of claim 1, further comprising transmitting resources in the blockchain through a bank transaction.

9. The method of claim 8, wherein the bank transaction is processed using a bank authorization code to determine the status of the transaction.

10. The method of claim 1, further comprising providing spending reports that summarize the matched offers for resources and the requests for resources.

11. A system for allocating resources comprising:
a processing device configured to receives a plurality of offers for resources, and transmit the offers for resources to a blockchain network, wherein the offers for resources is structured as a first set of transaction requests;
said processing device further configured to construct a request for resources, and transmit the requests for resources to the blockchain network, wherein the requests for resources are structured as second set of transaction requests;
said processing device further configured to apply a pairing algorithm to match the offers for resources to the requests for resources, wherein the algorithm comprises using a binary, iterative decision tree to match each of the offers for resources to one or more of the requests for resources, wherein the matched offers and requests are each recorded as a block to a blockchain, and wherein each block of the blockchain is comprised of a header, a subheader, a signed header from a bank, and a signed body.

12. The system of claim 11, wherein the offers for resources are a donation to a charity.

13. The system of claim 11, wherein the offers for resources are structured as an SQL-like query.

14. The system of claim 11, wherein the requests for resources are comprised of one or more parameters to build a specification.

15. The system of claim 14, wherein the processing device further extracts labels from the requests for resources' specifications, wherein said labels are used to match the request for resources to the offer for resources.

16. The system of claim 11, wherein the processing device further verifies and records vendor invoices to the blockchain.

17. The system of claim 11, wherein the decision tree is comprised of one or more nodes, wherein the nodes are comprised of categories for allocating the offers for resources.

18. The system of claim 11, wherein the processing device further transmits resources in the blockchain through a bank transaction.

19. The system of claim 18, wherein the bank transaction is processed using a bank authorization code to determine the status of the transaction.

20. The system of claim 11, wherein the processing device further provides spending reports that summarize the matched offers for resources and the requests for resources.
